(19) United States
(12) Patent Application Publication
(10) Pub. No.: US 2020/0128297 A1
(43) Pub. Date: Apr. 23, 2020

(54) Consumer Controlled Alternate Content Switching

(71) Applicant: Charter Communications Operating, LLC, St. Louis, MO (US)

(72) Inventor: Srilal M. Weerasinghe, Parker, CO (US)

(21) Appl. No.: 16/167,766

(22) Filed: Oct. 23, 2018

(51) Int. Cl. H04N 21/454; H04N 21/482; H04N 21/234; H04N 21/45

(52) U.S. Cl. CPC H04N 21/4542; H04N 21/4532; H04N 21/23424; H04N 21/4821

(57) ABSTRACT

Systems, methods, and devices of the various embodiments disclosed herein may enable unappealing television programs to be supplanted with alternate content based on customer preferences.

### BACKGROUND

In conventional television systems, a television viewer (or customer or user) often encounters a television program he or she dislikes on a given channel. In response, the television viewer can either watch the disliked program or change the channel in conventional television systems. The changing of the channel results in lost advertising revenue for the content provider of that channel in conventional television systems because the advertising availabilities in the television program the television viewer dislikes are not displayed to the television viewer after he or she changes the channel. Additionally, the frustration caused to television viewers by the inability to avoid disliked television programs in conventional television systems has increased the trend in television viewers canceling service contracts with content distributors (e.g., canceling cable television service from a cable television provider, sometimes called “cord cutting”) which has resulted in lost revenue for content distributors.

### SUMMARY

The systems, methods, and devices of the various embodiments disclosed herein may enable unappealing television programs to be supplanted with alternate content based on customer preferences. Various embodiments may provide methods for alternate content switching in which manifest files for Internet Protocol (IP) streaming content are modified based on user selections of alternate content provided by a programmer Various embodiments may provide a seamless user experience in which, after a user has indicated a program is unappealing, that unappealing program may be automatically replaced with programmer selected alternate content that is of interest to the user.

Various embodiments may provide a method for alternate content switching. The method may be implemented in a user computing device and may include determining that a current program on a user selected channel is on a dislike list, determining that programmer alternate content is available based at least in part on an indication in a program guide in response to determining that the current program on the user selected channel is on the dislike list, sending a manifest request for the current program on the user selected channel and a dislike indication in response to determining that programmer alternate content is available, receiving a manifest file for programmer alternate content on the user selected channel, and retrieving the programmer alternate content for output on the user selected channel according to the manifest file for the programmer alternate content on the user selected channel. The method may further include a network server, such as a manifest manipulator server, receiving the manifest request for the current program on the user selected channel and the dislike indication, retrieving binding data for the user computing device, the current program, and the programmer alternate content, modifying a manifest file for the current program according to the binding data to generate the manifest file for the programmer alternate content on the user selected channel, and sending the manifest file for the programmer alternate content on the user selected channel.

Further embodiments disclosed herein include a computing device having a processor configured with processor-executable instructions to perform operations of the methods summarized above. Further embodiments disclosed herein include a computing device including means for performing functions of the methods summarized above. Further embodiments disclosed herein include a non-transitory processor-readable storage medium having stored thereon processor-executable instructions configured to cause a computing device processor to perform operations of the methods summarized above. Further embodiments disclosed herein include a server configured with processor executable instructions to perform operations of the methods summarized above. Further embodiments disclosed herein include a server including means for performing functions of the methods summarized above. Further embodiments disclosed herein include a non-transitory processor-readable storage medium having stored thereon processor-executable instructions configured to cause a server processor to perform operations o of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a system block diagram of an Internet Protocol (IP) network suitable for use with the various embodiments.

FIG. 2 is a process flow diagram illustrating an embodiment method for generating a programmer alternate content mapping table.

FIG. 3 is a block diagram illustrating an embodiment programmer alternate content mapping table.

FIG. 4 is a process flow diagram illustrating an embodiment method for generating a program guide indicating programmer alternate content availability.

FIG. 5 is a process flow diagram illustrating an embodiment method for alternate content switching.

FIG. 6 is a process flow diagram illustrating an embodiment method for modifying a manifest file to enable alternate content switching.

FIG. 7A is a block diagram illustrating equal length alternate content replacement in an IP stream according to an embodiment.

FIG. 7B is a block diagram illustrating unequal length alternate content replacement in an IP stream according to an embodiment.

FIG. 7C is a block diagram illustrating another unequal length alternate content replacement in an IP stream according to an embodiment.

FIG. 8 is a process flow diagram illustrating an embodiment method for obtaining user dislike data and alternate content switching.

FIG. 9 is a block diagram illustrating an example user interface configured to obtain user dislike data and support alternate content switching according to various embodiments.

FIG. 10 is a process flow diagram illustrating an embodiment method for obtaining user dislike data.

FIG. 11 is a block diagram illustrating an embodiment dislike list.

FIG. 12A is a process flow diagram illustrating an embodiment method for storing binding data.

FIG. 12B is a process flow diagram illustrating an embodiment method for deleting binding data.

FIG. 13 is a call flow diagram illustrating an embodiment method for alternate content switching.

FIG. 14 is a component diagram of an example computing device suitable for use with various embodiments.

FIG. 15 is a component diagram of another example computing device suitable for use with various embodiments

FIG. 16 is a component diagram of another example computing device suitable for use with various embodiments.

FIG. 17 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “computing device” is used to refer to any one or all of satellite or cable set top boxes, laptop computers, rack mounted computers, routers, cellular telephones, smart phones, personal or mobile multi-media players, personal data assistants (PDAs), personal computers, tablet computers, smart books, palm-top computers, desk-top computers, wireless electronic mail receivers, multimedia Internet enabled cellular telephones, wireless gaming controllers, streaming media players (such as, ROKU™), smart televisions, digital video recorders (DVRs), modems, and similar electronic devices which include a programmable processor and memory and circuitry for providing the functionality described herein.

The various embodiments are described herein using the term “server” to refer to any computing device capable of functioning as a server, such as communications server, a name server, a master exchange server, web server, mail server, document server, database server, route server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as a server only to the extent necessary to provide the functionality described herein.

As used herein, the term “program” may refer to multimedia content, a television program, show, series, etc., that is provided by a programmer (e.g., Turner Broadcasting, ESPN, Disney, Viacom, etc.) to a content distributor network (e.g., Charter, Comcast, DirecTV, Sling TV etc.) for Internet Protocol (IP) streaming (e.g., adaptive bit rate (ABR) streaming, such as Apple Hypertext Transfer Protocol (HTTP) Live Streaming (Apple HLS), Dynamic Adaptive HTTP (DASH), etc., or any other type IP streaming) on a channel provided by the content distributor network and associated with that programmer Programmers (e.g., Turner Broadcasting, ESPN, etc.) may encode and package programs as content for delivery by the content distributor networks to users (also referred to as customers or viewers) via IP streaming services offered by the content distributor networks (e.g., Charter, Comcast, DirecTV, Sling TV etc.). The programs provided by the programmers may be grouped by programmer on one or more channels associated with each respective programmer provided by the content distributor networks. For example, a first channel may be dedicated by a content distributor network to programs provided by Turner Broadcasting and a second channel may be dedicated by the content distributor network to programs provided by ESPN. The programmers and content distributor networks may have contractual obligations with one another such that advertisements are included in the programs as the programs are output to the users (also referred to as customers or viewers) and compensation is exchanged between the programmers and content distributor networks based on the users viewing the included advertisements. Via his or her respective computing device, a user (also referred to as a customer or a viewer) may select a channel offered by his or her respective content distributor network (i.e., the content distributor network providing service to the user's computing device) to view programs provided by the programmer.

The systems, methods, and devices of the various embodiments disclosed herein may address the problems presented by television viewers (or customers or users) disliking a television program on a given channel in conventional systems by enabling unappealing television programs to be supplanted with alternate content based on customer preferences. The various embodiments may enable users to avoid seeing unappealing content without requiring the user to change the channel By retaining user viewership on the same channel, the various embodiments may prevent programmers from losing revenue because the programmer's advertisements on the channel may still be shown to the user. Additionally, the various embodiments may maintain contractual obligations between programmers and content distributor networks because, while the user is enabled to avoid disliked programs, the alternate content replacing those dislike programs may be limited to other alternate programs of selected by the programmer.

In various embodiments, a programmer may determine alternate content for one or more programs the programmer is providing to a content distributor network. As used herein, the term “alternate content” may refer to one or more programmer selected programs that may replace a program of the programmer in a program schedule. For example, alternate content for a regularly scheduled program (or original program) may be a different program provided by the programmer that the programmer determines may replace the regularly scheduled program (or original program). As a specific example, according to the programmer's programming schedule, an original program, Ghoul Adventures, may be selected for streaming on a channel assigned to the programmer in a given time slot. The programmer may identify three other programs the programmer also provides, Weird Foods, Museum Mystery, and Without Reservations, as alternate content for the original program, Ghoul Adventures. In this manner, the programmer may identify that any of the alternate content, Weird Foods, Museum Mystery, and Without Reservations, may be programs substituted for the original program, Ghoul Adventures. As examples, alternate content may be programs specifically reserved as alternate content or may be programs aired by the programmer earlier or later in the day.

In various embodiments, a programmer may generate a programmer alternate content mapping table for the programmer's program schedule indicating the determined programmer alternate content. The programmer alternate content mapping table may correlate original programs and the programmer selected alternate content for those original programs (i.e., the programs selectable to replace the original programs). In various embodiments, the programmer may send the programmer schedule and programmer alternate content mapping table to a guide vendor (e.g., Gracenote, Rovi, etc.). In various embodiments, the guide vendor may combine the programmer schedules and programmer alternate content mapping tables from multiple programmers into a program guide indicating programmer alternate content availability. In various embodiments, the program guide indicating programmer alternate content availability may be provided to content distributor networks and/or user computing devices. In various embodiments, the content distributor networks may provide the program guide indicating programmer alternate content availability to user computing devices receiving services from the content distributor networks.

Various embodiments may provide for alternate content switching based on user dislikes. In various embodiments, a user may identify a program that is unappealing to him or her. The user may identify an unappealing (or disliked) program by selecting the program as disliked and indicating one or more other programs (i.e., programmer alternate content) available from the programmer providing the disliked program as preferred over the disliked program. As one example, the user may identify an unappealing (or disliked) program by interfacing with an electronic program guide. As another example, the user may identify an unappealing (or disliked) program using a web portal provided by a content distributor network. As a further example, the user may identify an unappealing (or disliked) program via an application on a user's computing device supported by an application programming interface (API) to provide the user's identification of the disliked program to the content distributor network.

In various embodiments, in response to the user identifying an unappealing (or disliked) program, the user may make a selection of programmer alternate content available for the unappealing (or disliked) program. For example, the user may select a program from a list of programmer alternate content that the user prefers to replace the unappealing (or disliked) program. As a specific example, the programmer may have identified the programs Weird Foods, Museum Mystery, and Without Reservations, as available programmer alternate content for the program Ghoul Adventures. The user may indicate that he or she dislikes Ghoul Adventures and may select Weird Foods as programmer alternate content. In some embodiments, the identification of an unappealing (or disliked) program by a user and the selection of programmer alternate content may occur prior to a user selecting a channel for viewing. For example, a user may indicate dislikes and programmer alternate content selections via a web portal or application on his or her computing device before the user watches television. As another example, the user may indicate dislikes and programmer alternate content selections via an electronic program guide before selecting a channel to watch. In some embodiments, the identification of an unappealing (or disliked) program by a user and the selection of programmer alternate content may occur while the user is watching television on a selected channel. For example, a user may select an alternate content button or icon to trigger alternate content switching.

In various embodiments, programs identified by a user as unappealing (or disliked) may be added to a dislike list stored on a user's computing device. A dislike list may be a listing of programs identified by the user as unappealing (or disliked). In various embodiments, programs may be added to, or deleted from, the dislike list by a user. In various embodiments, programs identified by a user as unappealing (or disliked) and user selections of programmer alternate content available for such unappealing (or disliked) programs may be sent to a server of a content distributor network, such as an alternate content server. In various embodiments, a server of a content distributor network, such as an alternate content server, may store binding data relating an identifier of the user, such as the user's computing device identifier (e.g., Media Access Control Identifier (MAC ID), etc.), subscribed identifier, etc., a user dislike (e.g., the name of the program disliked by the user, etc.), and the user selection of the programmer alternate content. In this manner, a database of user's disliked programs and the user's preferred programmer alternate content may be established at a server of a content distributor network, such as an alternate content server. Such binding data may be referenced to select programmer alternate content with which to replace unappealing (or disliked) programs for each respective user. In various embodiments, binding data may be updated and/or deleted based on subsequent user preference changes.

In various embodiments, current programs aired on a user selected channel may be compared against the dislike list. When alternate content is available, in response to determining that the current program being aired on the user selected channel is on the dislike list, alternate content for the current program the user selected channel is airing may be requested. In various embodiments, in response to determining that the current program being aired on the user selected channel is on the dislike list, a user's computing device may send a manifest request for the current program on the user selected channel along with a dislike indication. For example, the manifest request may be an HTTP GET command. The dislike indication may be an element in the manifest request itself indicating the current program is on the dislike list or the dislike indication may be a separate message indicating the current program is on the dislike list. The manifest request and dislike indication may be sent to a server of a content distributor network, such as a manifest manipulator server.

In various embodiments, in response to receiving the dislike indication, a server of a content distributor network, such as a manifest manipulator server, may retrieve binding data for the user computing device, the current program being aired, and the programmer alternate content. For example, the binding data may be retrieved from a server of a content distributor network, such as an alternate content server. In various embodiments, the server of a content distributor network, such as a manifest manipulator server, may modify the manifest file for the current program according to the retrieved binding data to generate a manifest file for the programmer alternate content on the user selected channel. As used herein, the term “manifest file” may refer to a manifest or index type file, such as a .mpd type file for DASH, .m3u8 type file for Apple HLS, etc., that describes the media segments for IP streaming to be requested, received, and output by a user's computing device to display a program to the user. Manifest files may define the segments of programs provided by a programmer as well as segments for advertisements to be displayed according to an ad plan for a given program or channel Manifest files for programs may be pre-generated by a content distributor server based on the programmer content received by the content distributor network and program guide for content to be made available by the content distributor network. In various embodiments, modifying a manifest file may include changing the program referenced in the manifest file. For example, the manifest file for the current program may be overwritten to replace the current program that was unappealing (or disliked) by the user with the programmer alternate content selected by the user. In this manner, the manifest file for the current program may be modified to generate a manifest file for the programmer alternate content that may be used to retrieve and output the programmer alternate content rather than the current program. The manifest file for the programmer alternate content may retain the same advertising availabilities and segments for advertisements to be displayed according to the ad plan as were present in the manifest file before it was modified. In this manner, the same advertisements may be output on the channel despite the manifest file being modified. The manifest file for the programmer alternate content may be sent to the computing device of the user that disliked the current program and the user's computing device may retrieve and output the programmer alternate content on the user selected channel according to that modified manifest file. For example, the user's computing device may send HTTP GET commands to an origin server storing the alternate content to stream the alternate content to the user's computing device. In this manner, the user's computing device may receive the media segments for the alternate content, stitch those media segments together, and play out the alternate content to the user on a display.

In various embodiments, programmer alternate content selected by the programmer for replacement of an unappealing (or disliked) program may be the same length programs (i.e., having the same runtime and therefore same program boundaries). In such embodiments, the substitution of the programmer alternate content may be a one-to-one substitution. In other embodiments, the programmer alternate content selected by the programmer for replacement of an unappealing (or disliked) program may be different length programs (i.e., have different runtimes and different program boundaries). In various embodiments, any portion of the alternate content that is longer than the program boundary for the replaced unappealing (or disliked) program may be unused such that at the program boundary for the replaced unappealing (or disliked) program, the output on the channel may revert to the program schedule. In some embodiments, when the programmer alternate content is shorter than the unappealing (or disliked) program, a second programmer alternate content (i.e., a second program) may be appended to the end of the shorter programmer alternate content. In some embodiments, when the programmer alternate content is shorter than the unappealing (or disliked) program an option may be presented to the user to select a second alternate content or revert to the remaining portion of the unappealing (or disliked program). In some embodiments, when the programmer alternate content is shorter than the unappealing (or disliked) program, the output on the channel may automatically revert to the remaining portion of the unappealing (or disliked program). In various embodiments, the program boundaries for the unappealing (or disliked program) may be enforced by an alternate content generator (ACG) module running on a processor of the user's computing device. In various embodiments, the ACG module may be further configured to obtain user preferences, maintain a dislike list, and/or determine whether a current program is on a dislike list.

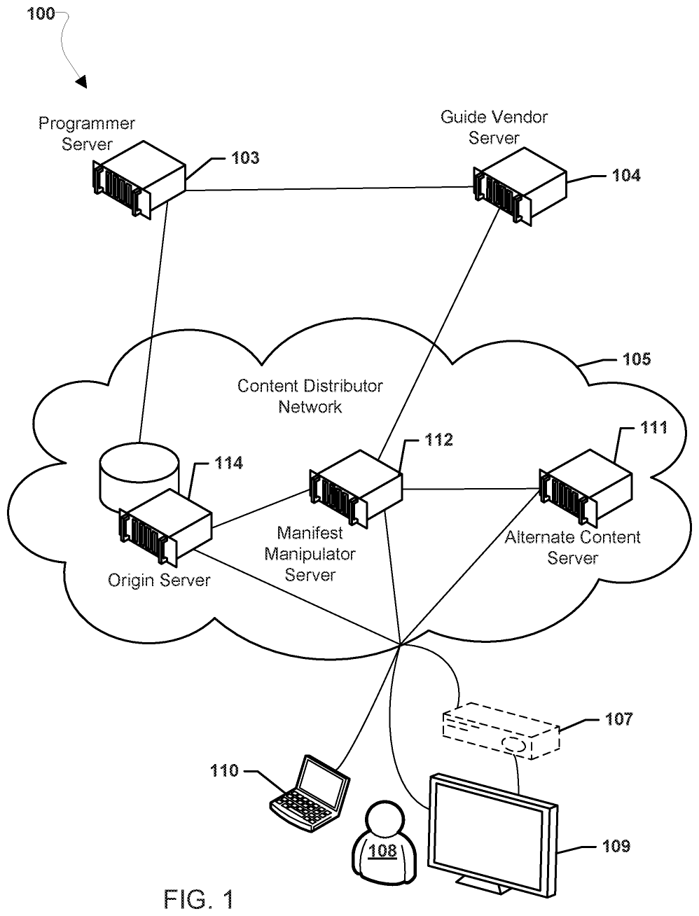

FIG. 1 is a system block diagram of an IP network 100 suitable for use with the various embodiments. The IP network 100 may include one or more programmer servers 103, one or more guide vendor servers 104, one or more content distributor networks 105, and user computing devices 107, 109, 110. The programmer servers 103, guide vendor servers 104, content distributor networks 105, and user computing devices 107, 109, 110 may be connected together via one or more wired and/or wireless connections, such as connections to wired and/or wireless networks (e.g., connections to the Internet), and via those connections may exchange data with one another. In various embodiments, a content distributor network 105 may include various interconnected computing devices, such as an origin server 114, manifest manipulator server 112, and alternate content server 111. Via their connections (wired and/or wireless) with one another, the origin server 114, the manifest manipulator server 112, and the alternate content server 111 may exchange data with one another. In various embodiments, the content distributor network 105 may be operated by a content distributor (e.g., Charter, Comcast, DirecTV, Sling TV etc.) and may provide television services via IP streaming (e.g., ABR streaming, such as Apple HLS, DASH, etc., or any other type IP streaming) to users, such as user 108, via one or more of his or her computing devices 107, 109, 110. As an example, user computing device 107 may be a streaming media player (e.g., a ROKU, etc.) connected to user computing device 109 which may be a television. User computing device 107 may be optional as user computing device 109 may itself connect to the content distributor network 105. For example, user computing device 109 may be a smart television. As another example, user computing device 110 may be a laptop computer.

In various embodiments, the programmer server 103 may be a server of a programmer (e.g., Turner Broadcasting, ESPN, Disney, Viacom, etc.) that provides content, such as programs, for viewing by users, such as user 108, via the content distributor network 105. For example, the programmer server 103 may provide programmer content (i.e., programs) to the origin server 114. An encoder and packager at the programmer server 103 or origin server 114 may format the programmer content and the origin server 114 may store the programmer content (i.e., programs) for IP streaming. While the origin server 114 is illustrated in FIG. 1 as part of the content distributor network 105, the origin server 114 may be a server of a separate content delivery network (CDN) service, such as Akamai Networks, Amazon Web Services, etc., to which the content distributor network 105 operator or programmer offloads content storage and delivery. The programmer server 103 may also be configured to determine alternate content for the programs in a programming schedule and generate a programmer alternate content mapping table for the program schedule indicating the determined programmer alternate content. The programmer server 103 may send the program schedule and the programmer alternate content mapping table to the guide vendor server 104.

The guide vendor server 104 may be configured to receive program schedules and programmer alternate content mapping tables from various programmers and generate a program guide indicating programmer alternate content availability. The guide vendor server 104 may be a server operated by a guide vendor (e.g., Gracenote, Rovi, etc.). The guide vendor server 104 may send the program guide indicating programmer alternate content availability to the content distributor network 105, such as to the manifest manipulator server 112. In various embodiments, the content distributor network 105, such as the manifest manipulator server 112, may provide the program guide indicating programmer alternate content availability to the user computing devices 107, 109, 110. Alternatively, the program guide indicating programmer alternate content availability may be provided from the guide vendor server 104 to the user computing devices 107, 109, 110.

The manifest manipulator server 112 may be configured to generate manifest files, such as a .mpd type files for DASH, .m3u8 type files for Apple HLS, etc., that describe the programmer content provided by the programmer server 103 and stored at the origin server 114. The manifest files may be stored at the origin server 114 and may defined the segments of programs provided by a programmer server 103 as well as segments for advertisements to be displayed according to an ad plan for a given program or channel Manifest files may be pre-generated by the manifest manipulator server 112 based on the program guide from the guide vendor server 104. In various embodiments, the manifest manipulator server 112 may be configured to modify the pre-generated manifest files to generate manifest files for programmer alternate content. The manifest manipulator server 112 may provide manifest files to requesting ones of the user computing devices 107, 109, 110. The user computing devices 107, 109, 110 may use the manifest files to retrieve and output programmer content, including programmer alternate content, to the user 108. For example, based on a manifest file, the user computing device 107, 109, 110 may stream segments of a program from the origin server 114.

In various embodiments, the user computing devices 107, 109, 110 may be configured to indicate user selections of programmer alternate content to the content distributor network 105, such as to the alternate content server 111. The alternate content server 111 may store binding data relating an identifier of the user 108, such as the user's computing device identifier (e.g., MAC ID, etc.), subscribed identifier, etc., a user dislike (e.g., the name of the program disliked by the user, etc.), and the user selection of the programmer alternate content. In this manner, a database of user's 108 disliked programs and the user's 108 preferred programmer alternate content may be established at the alternate content server 111. Such binding data may be referenced to select programmer alternate content with which to replace unappealing (or disliked) programs for the user 108.

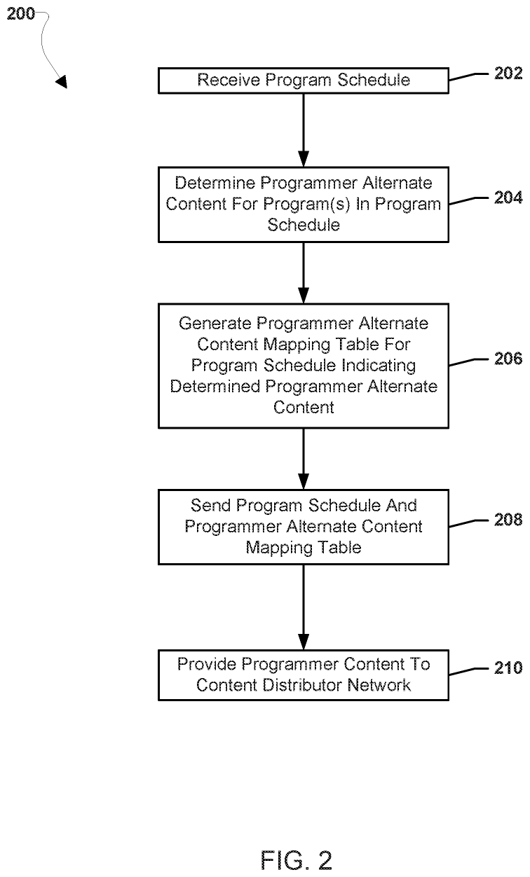

FIG. 2 illustrates an embodiment method 200 for generating a programmer alternate content mapping table. With reference to FIGS. 1-2, the operations of method 200 may be performed by a processor of a programmer server, such as programmer server 103.

In block 202, the server may receive a program schedule. A program schedule may be a listing of programs and corresponding times at which the programs are to be aired on a channel associated with a programmer. The program schedule may be determined by a programmer and may reflect the programs to be aired on the programmer's channel at given times. The programs in the program schedule may be programs created by the programmer.

In block 204, the server may determine programmer alternate content for one or more programs in the program schedule. The alternate content may be programmer selected programs that may replace a program of the programmer in the program schedule. For example, alternate content for a regularly scheduled program (or original program) may be a different program provided by the programmer that the programmer determines may replace the regularly scheduled program (or original program). As a specific example, according to the programmer's programming schedule, an original program, Ghoul Adventures, may be selected for streaming on a channel assigned to the programmer in a given time slot. The programmer may identify three other programs the programmer also provides, Weird Foods, Museum Mystery, and Without Reservations, as alternate content for the original program, Ghoul Adventures. In this manner, the programmer may determine that any of the alternate content, Weird Foods, Museum Mystery, and Without Reservations, may be programs substituted for the original program, Ghoul Adventures. As examples, alternate content may be programs specifically reserved as alternate content or may be programs aired by the programmer earlier in the day

In block 206, the server may generate a programmer alternate content mapping table for the program schedule indicating the determined programmer alternate content. The programmer alternate content mapping table may correlate original programs and the programmer selected alternate content for those original programs (i.e., the programs selectable to replace the original programs).

In block 208, the server may send the program schedule and programmer alternate content mapping table. In various embodiments, the programmer may send the programmer schedule and programmer alternate content mapping table to a guide vendor (e.g., Gracenote, Rovi, etc.).

In block 210, the server may provide programmer content to the content distributor network. For example, the server may send programmer content to an origin server, such as origin server 114, to make the programmer content available for IP streaming from the origin server.

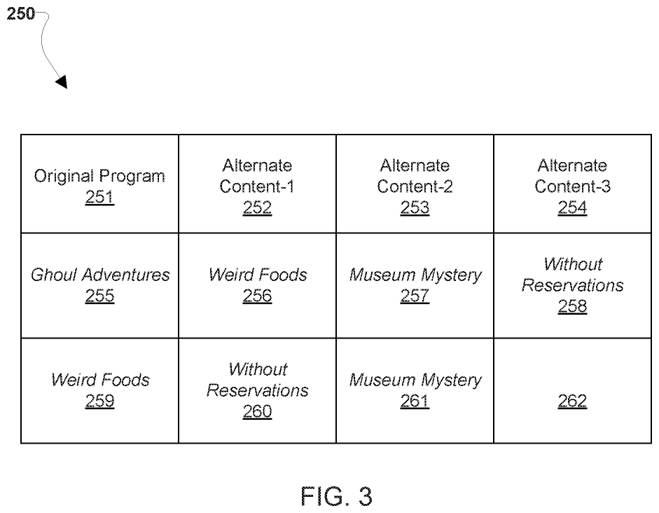

FIG. 3 is a block diagram illustrating an embodiment programmer alternate content mapping table 250. With reference to FIGS. 1-3, the programmer alternate content mapping table 250 may be generated according to the operations of method 200 (FIG. 2). The programmer alternate content mapping table 250 may correlate original programs 251 with alternate content, e.g., alternate content-1 252, alternate content-2 253, alternate content-3 254. The alternate content-1 252, alternate content-2 253, alternate content-3 254 may be programs that the programmer selects as available to replace the original program 251 should a user find the original program 251 unappealing (i.e., disliked). As an example, the programmer may define in the programmer alternate content mapping table 250 that the original program Ghoul Adventures 255 may be substituted by any one of programmer alternate content Weird Foods 256, Museum Mystery 257, or Without Reservations 258. These programs Weird Foods 256, Museum Mystery 257, or Without Reservations 258, may be the alternate content that may be selected by a user to replace the program Ghoul Adventures 255. Similarly, the programmer may define in the programmer alternate content mapping table 250 that the original program Weird Foods 259 may be substituted by any one of programmer alternate content Without Reservations 260 or Museum Mystery 261. These programs Without Reservations 260 and Museum Mystery 261, may be the alternate content that may be selected by a user to replace the program Weird Foods 259. The third alternate content position in the programmer alternate content mapping table 250 for the original program Weird Foods 259 may reflect a blank 262 indicating that only two programs were selected by the programmer as alternate content for the original program Weird Foods 259.

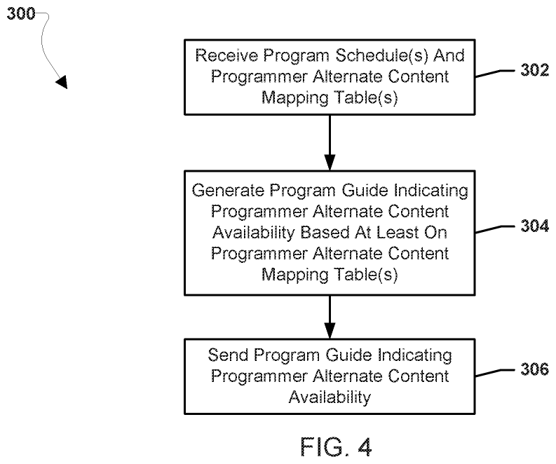

FIG. 4 illustrates an embodiment method 300 for generating a program guide indicating programmer alternate content availability. With reference to FIGS. 1-3, the operations of method 300 may be performed by a processor of a guide vendor server, such as guide vendor server 104. In various embodiments, the operations of method 300 may be performed in conjunction with the operations of method 200 (FIG. 2).

In block 302, the server may receive one or more program schedules and one or more programmer alternate content mapping tables. For example, the server may receive program schedules and programmer alternate content mapping tables from each programmer that may provide a channel for users to view.

In block 304, the server may generate a program guide indicating programmer alternate content availability based at least on the one or more programmer alternate content mapping tables. In various embodiments, the guide vendor may combine the programmer schedules and programmer alternate content mapping tables from multiple programmers into a program guide indicating programmer alternate content availability. The program guide indicating programmer alternate content availability may correlate programs in the program schedules of the programmers with the programmer selected alternate content indicated in the programmer alternate content mapping tables. In this manner, one program guide for all channels may be formed by the guide vendor.

In block 306, the server may send the program guide indicating the programmer alternate content availability. In various embodiments, the program guide indicating programmer alternate content availability may be provided to content distributor networks and/or user computing devices. For example, the server may send program guide to a server of a content distributor network, such as a manifest manipulator server. The server of a content distributor network, such as a manifest manipulator server, may use the program guide to generate manifest files for the programs in the program guide. Additionally, the server of a content distributor network, such as a manifest manipulator server, may send the program guide to user computing devices receiving IP streaming services from the content distributor network.

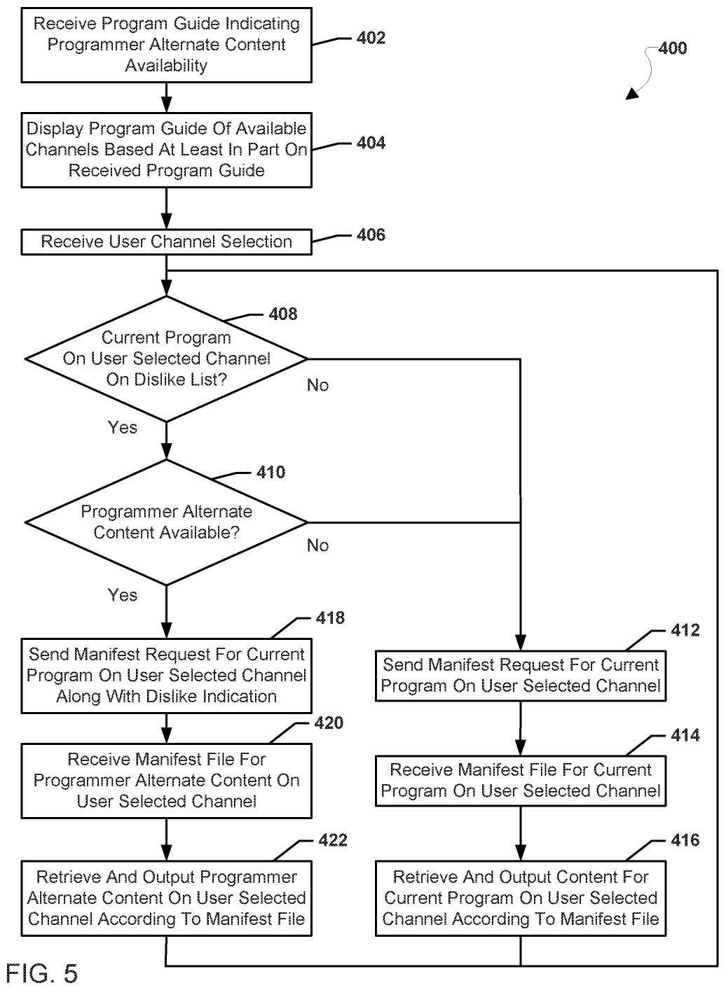

FIG. 5 illustrates an embodiment method 400 for alternate content switching. With reference to FIGS. 1-4, the operations of method 400 may be performed by a processor of a user computing device, such as user computing devices 107, 109, 110. As a specific example, the operations of method 400 may be performed by an ACG module running on a processor of a user computing device. In various embodiments, the operations of method 400 may be performed in conjunction with the operations of method 200 (FIG. 2) and/or 300 (FIG. 4).

In block 402, the processor may receive a program guide indicating programmer alternate content availability. The program guide indicating programmer alternate content availability may correlate programs in the program schedules of the programmers associated with various channels with the programmer selected alternate content for the programs in the program schedule. The program guide indicating the programmer alternate content availability may be received from a server of a content distributor network, such as a manifest manipulator server.

In block 404, the processor may display a program guide of available channels based at least in part on the received program guide. The program guide may be an electronic program guide enabling users to select a channel to watch.

In block 406, the processor may receive a user channel selection. For example, a user may select a channel to tune to (i.e., watch) by selecting the channel via a remote or other human machine interface from an electronic program guide. Alternatively, a user may input a channel number assigned to a channel to make a user channel selection or interact in any manner with the user computing device to select a channel.

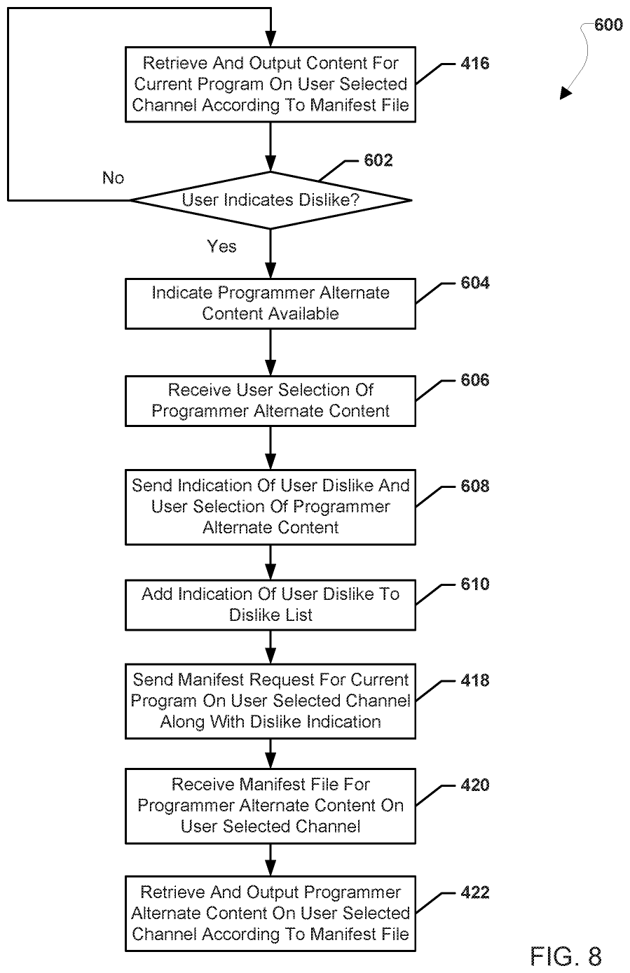

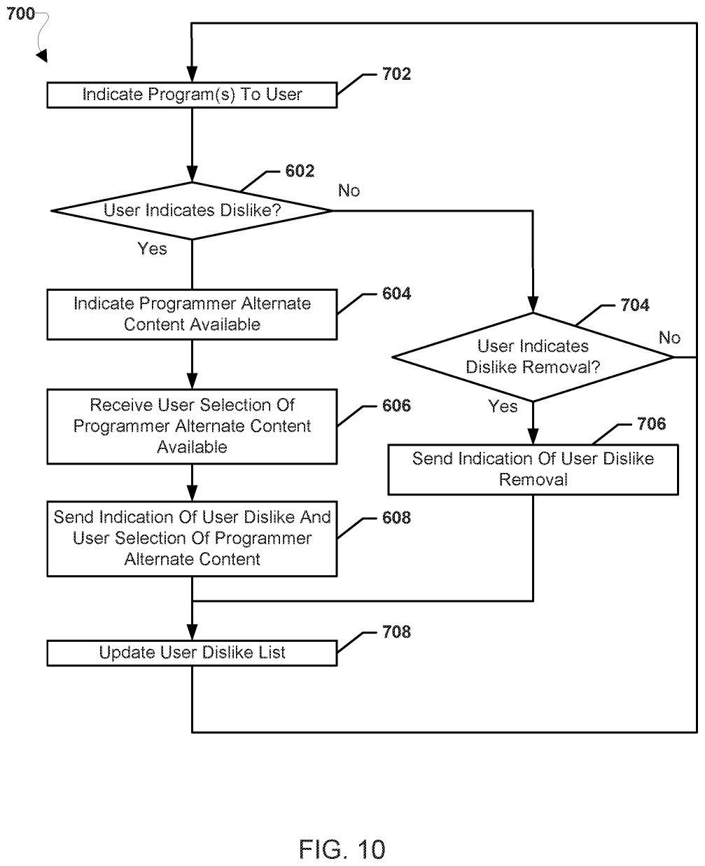

In determination block 408, the processor may determine whether the current program on the user selected channel is on a dislike list. A dislike list may be a listing of programs identified by the user as unappealing (or disliked). In various embodiments, programs may be added to, or deleted from, the dislike list by a user. In various embodiments, the dislike list may be stored in a memory of the user computing device. Dislike lists may be generated in various manners, including according to the operations of methods 600 (FIG. 8) and/or 700 (FIG. 10). To determine whether the current program on the user selected channel is on a dislike list, the processor may compare the title of the program currently being aired on the user selected channel according to the program guide to the titles of programs stored in the dislike list. A match between the title of the program currently being aired and a title in the dislike list may indicate the current program on the user selected channel is on the dislike list.

In response to determining that the current program on the user selected channel is on the dislike list (i.e., determination block 408=“Yes”), the processor may determine whether programmer alternate content is available in determination block 410. For example, the processor may determine whether the program guide indicates programmer alternate content is available for the current program.

In response to determining that that the current program on the user selected channel is not on the dislike list (i.e., determination block 408=“No”) or in response to determining that programmer alternate content is not available (i.e., determination block 410=“No”), the processor may send a manifest request for the current program on the user selected channel in block 412. For example, the manifest request may be an HTTP GET command. The manifest request may be sent to a server of a content distributor network, such as a manifest manipulator server. The manifest request may identify the title of the current program being aired on the user selected channel according to the program guide. Additionally, the manifest request may include an identifier of the user computing device sending the manifest request.

In block 414, the processor may receive a manifest file for the current program on the user selected channel. The manifest file may be received from a server of a content distributor network, such as a manifest manipulator server. The manifest file may be a manifest or index type file, such as a .mpd type file for DASH, .m3u8 type file for Apple HLS, etc., that describes the media segments for IP streaming of the current program on the user selected channel.

In block 416, the processor may retrieve and output content for the current program on the user selected channel according to the manifest file. For example, the processor may send HTTP GET commands to an origin server, such as origin server 114, storing the segments of the current program to stream the current program to the user's computing device.

In response to determining that programmer alternate content is available (i.e., determination block 410=“Yes”), the processor may send a manifest request for the program on the user selected channel along with a dislike indication in block 418. In various embodiments, in response to determining that the current program being aired on the user selected channel is on the dislike list, a user's computing device may send a manifest request for the current program on the user selected channel along with a dislike indication. For example, the manifest request may be an HTTP GET command. The dislike indication may be an element in the manifest request itself indicating the current program is on the dislike list or the dislike indication may be a separate message indicating the current program is on the dislike list. The manifest request and dislike indication may be sent to a server of a content distributor network, such as a manifest manipulator server. The manifest request may identify the title of the current program being aired on the user selected channel according to the program guide. Additionally, the manifest request may include an identifier of the user computing device sending the manifest request.

In block 420, the processor may receive a manifest file for programmer alternate content on the selected channel. The manifest file may be received from a server of a content distributor network, such as a manifest manipulator server. The manifest file may be a manifest or index type file, such as a .mpd type file for DASH, .m3u8 type file for Apple HLS, etc., that describes the media segments for IP streaming of the alternate content on the user selected channel.

In block 422, the processor may retrieve and output programmer alternate content on the user selected channel according to the manifest file. For example, the processor may send HTTP GET commands to an origin server, such as origin server 114, storing the alternate content to stream the alternate content to the user's computing device. In this mariner, the user's computing device may receive the media segments for the alternate content, stitch those media segments together, and play out the alternate content to the user in place of the current program indicated in the program guide. As the manifest file for the programmer alternate content may retain the same advertising availabilities and segments for advertisements to be displayed according to the ad plan as would have been present in the manifest file for the current program, the user may view the same advertisements as would have been viewed had the disliked program been viewed. In this manner, the programmer may receive the same revenue in the timeslot whether the user views the current program or the alternate content.

Upon outputting the current program in block 416 or the programmer alternate content in block 422, the processor may proceed to determination block 408. In this manner, upon a user channel selection and/or upon the start of a next program, the processor may determine whether the current program is on the dislike list in block 408 and may prevent disliked programs from being shown to the user when alternate content is available.

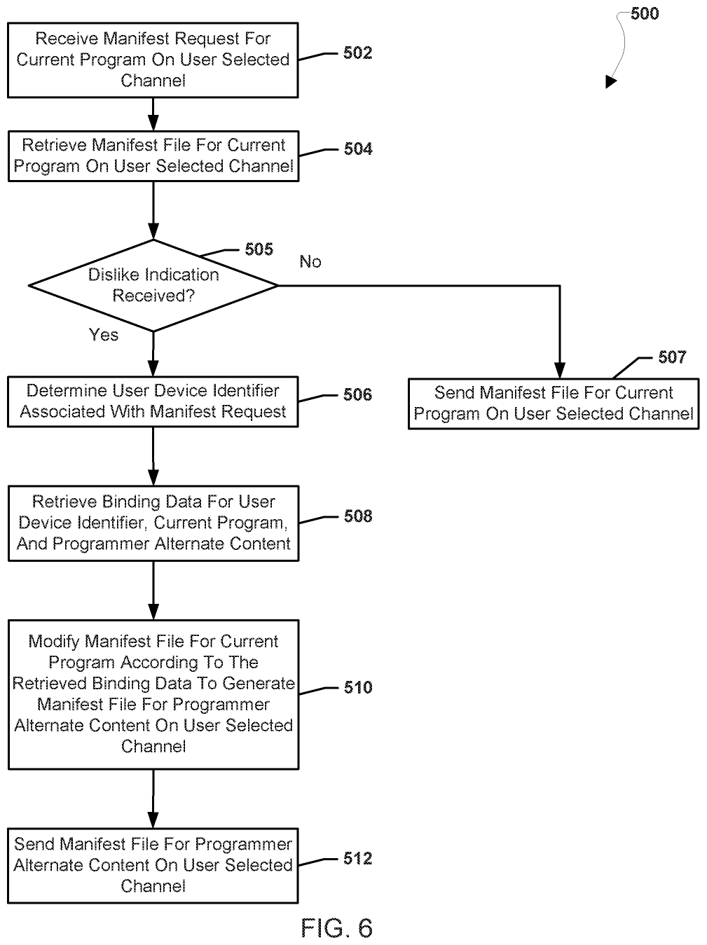

FIG. 6 illustrates an embodiment method 500 for modifying a manifest file to enable alternate content switching. With reference to FIGS. 1-6, the operations of method 500 may be performed by a processor of a server of a content distributor network (e.g., content distributor network 105), such as a manifest manipulator server (e.g., manifest manipulator server 112). In various embodiments, the operations of method 500 may be performed in conjunction with the operations of method 200 (FIG. 2), method 300 (FIG. 4), and/or method 400 (FIG. 5).

In block 502, the server may receive a manifest request for a current program on a user selected channel. For example, the manifest request may be an HTTP GET command received from a user computing device. In some embodiments, a manifest request may be sent along with a dislike indication. The dislike indication may be an element in the manifest request itself indicating the current program is on the dislike list or the dislike indication may be a separate message indicating the current program is on the dislike list. The manifest request may identify the title of the current program being aired on the user selected channel according to the program guide. Additionally, the manifest request may include an identifier of the user computing device sending the manifest request.

In block 504, the server may retrieve a manifest file for the current program on the user selected channel. As an example, manifest files for programs to be aired according to a program guide may be pre-generated and stored in an origin server, such as origin server 114. The server may retrieve the manifest file corresponding to the title of the current program being aired on the user selected channel indicated in the manifest request.

In determination block 505, the server may determine whether a dislike indication is received. In some embodiments, a manifest request may be sent along with a dislike indication. The dislike indication may be an element in the manifest request itself indicating the current program is on the dislike list or the dislike indication may be a separate message indicating the current program is on the dislike list. The server may determine whether a dislike indication is received by determining whether a separate dislike indication message was received and/or by parsing the manifest request to determine whether a dislike indication is present in the manifest request.

In response to determining that a dislike indication is not received (i.e., determination block 505=“No”), the server may send the manifest file for the current program on the user selected channel in block 507. The lack of a dislike indication may single that the current program is not unappealing (or not disliked) by the user and the current program the manifest file may be provide to enable streaming of the current program.

In response to determining that a dislike indication is received (i.e., determination block 505=“Yes”), the server may determine a user device identifier associated with the manifest request in block 506. The device identifier may be indicated in the manifest request. The device identifier may be associated with the user viewing the current channel, such as the user's computing device identifier (e.g., MAC ID, etc.), subscribed identifier, etc.

In block 508, the server may retrieve binding data for the user device identifier, the current program, and the programmer alternate content. In various embodiments, a server of a content distributor network, such as a alternate content server (e.g., alternate content server 111), may store binding data relating an identifier of the user, such as the user's computing device identifier (e.g., MAC ID, etc.), subscribed identifier, etc., a user dislike (e.g., the name of the program disliked by the user, etc.), and the user selection of the programmer alternate content. In this manner, a database of user's disliked programs and the user's preferred programmer alternate content may be established at a server of a content distributor network, such as an alternate content server. Such binding data may be referenced to select programmer alternate content with which to replace unappealing (or disliked) programs for each respective user.

In block 510, the server may modify the manifest file for the current program according to the retrieved binding data to generate a manifest file for programmer alternate content on the user selected channel. In various embodiments, modifying a manifest file may include changing the program referenced in the manifest file. For example, the manifest file for the current program may be overwritten to replace the current program that was unappealing (or disliked) by the user with the programmer alternate content selected by the user. In this manner, the manifest file for the current program may be modified to generate a manifest file for the programmer alternate content that may be used to retrieve and output the programmer alternate content rather than the current program. The manifest file for the programmer alternate content may retain the same advertising availabilities and segments for advertisements to be displayed according to the ad plan as were present in the manifest file before it was modified. In this manner, the same advertisements may be output on the channel despite the manifest file being modified.

In block 512, the server may send the manifest file for the programmer alternate content on the user selected channel. The manifest file for the programmer alternate content may be sent to the computing device of the user that disliked the current program and the user's computing device may retrieve and output the programmer alternate content on the user selected channel according to that modified manifest file.

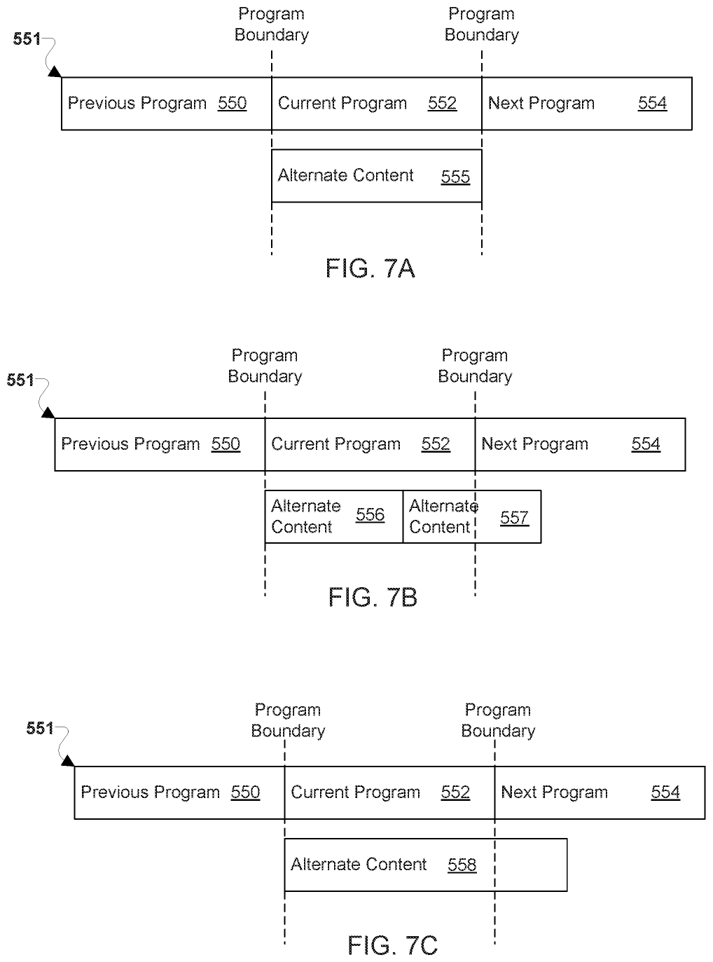

FIGS. 7A, 7B, and 7C illustrate different length programmer alternate content replacements in an IP stream 551 according to various embodiments.

With reference to FIGS. 1-7C, FIG. 7A illustrates an equal length alternate content replacement in an IP stream 551 according to an embodiment. The IP stream 551 may correspond to the programs in a program guide that are to be aired on a user selected channel at various times. For example, a previous program 550 may be aired until the program boundary (or time) at which the current program 552 is to start airing on the channel. The current program 552 may air until the program boundary (or time) at which the next program 554 is to be aired according to the program guide. In various embodiments, programmer alternate content 555 selected by the programmer for replacement of an unappealing (or disliked) program (i.e., current program 552) may be the same length programs (i.e., having the same runtime and therefore same program boundaries). In such embodiments, the substitution of the programmer alternate content 555 for the current program 552 may be a one-to-one substitution. In various embodiments, the program boundaries for the unappealing (or disliked program) (i.e., current program 552) may be enforced by an ACG module running on a processor of a user computing device. For example, at the time when the current program 552 is slated to end and the next program 554 is to begin, the ACG module may stop the streaming of the programmer alternate content 555. In this manner, content replacement may end upon reaching a program boundary of the current program 552.

In other embodiments, the programmer alternate content selected by the programmer for replacement of an unappealing (or disliked) program (i.e., current program 552) may be different length programs (i.e., have different runtimes and different program boundaries) than the current program 552. FIG. 7B illustrates an example of two programmer alternate content 556 and 557 programs being selected to supplant current program 552. In some embodiments, when the programmer alternate content 556 is shorter than the unappealing (or disliked) program (i.e., current program 552), a second programmer alternate content 557 may be appended to the end of the shorter programmer alternate content 556 to fill the time slot of the current program 552. In various embodiments, any portion of the programmer alternate content 557 that is longer than the program boundary for the replaced unappealing (or disliked) program (i.e., current program 552) may be unused such that at the program boundary for the replaced unappealing (or disliked) program (i.e., current program 552), the output on the channel may revert to the program schedule and begin streaming the next program 554. Similarly, in some embodiments, when the programmer alternate content 556 is shorter than the unappealing (or disliked) program (i.e., current program 552), an option may be presented to the user to select a second alternate content 557 or revert to the remaining portion of the unappealing (or disliked program)(i.e., current program 552). In some embodiments, when the programmer alternate content 556 is shorter than the unappealing (or disliked) program (i.e., current program 552), the output on the channel may automatically revert to the remaining portion of the unappealing (or disliked program)(i.e., current program 552).

As illustrated in FIG. 7C is a block diagram illustrating another unequal length alternate content replacement in an IP stream according to an embodiment. In FIG. 7C, the programmer alternate content 558 is longer than the current program 552 it replaces. In various embodiments, any portion of the alternate content 558 that is longer than the program boundary for the replaced unappealing (or disliked) program (i.e., current program 552) may be unused such that at the program boundary for the replaced unappealing (or disliked) program (i.e., current program 552) the output on the channel may revert to the program schedule and air next program 554.

FIG. 8 illustrates an embodiment method 600 for obtaining user dislike data and alternate content switching. With reference to FIGS. 1-8, the operations of method 600 may be performed by a processor of a user computing device, such as user computing devices 107, 109, 110. As a specific example, the operations of method 600 may be performed by an ACG module running on a processor of a user computing device. In various embodiments, the operations of method 600 may be performed in conjunction with the operations of method 200 (FIG. 2), 300 (FIG. 4), 400 (FIG. 5), and/or 500 (FIG. 6).

In block 416, the processor may retrieve and output content for a current program on a user selected channel according to a manifest file as described with reference to like numbered block of method 400 (FIG. 5).

In determination block 602, the processor may determine whether a user indicates a dislike. In some embodiments, the identification of an unappealing (or disliked) program by a user and the selection of programmer alternate content may occur while the user is watching television on a selected channel. For example, a user may select an alternate content button or icon to trigger alternate content switching. The selection of an alternate content button or icon may be an indication of a dislike of the current program.

In response to determining no dislike is indicated (i.e., determination block 602=“No”), the processor may continue to output content in block 416.

In response to determining that a dislike is indicated (i.e., determination block 602=“Yes”), the processor may indicate programmer alternate content is available in block 604. For example, the processor may display a user interface indicating the programmer alternate content available for the current program according to the program guide.

In block 606, the processor may receive a user selection of programmer alternate content. For example, the user may select a program from a list of programmer alternate content that the user prefers to replace the unappealing (or disliked) program.

In block 608, the processor may send an indication of the user dislike and user selection of the programmer alternate content. In various embodiments, programs identified by a user as unappealing (or disliked) and user selections of programmer alternate content available for such unappealing (or disliked) programs may be sent to a server of a content distributor network, such as an alternate content server.

In block 610, the processor may add an indication of a user dislike to a dislike list. In various embodiments, programs identified by a user as unappealing (or disliked) may be added to a dislike list stored on a user's computing device. A dislike list may be a listing of programs identified by the user as unappealing (or disliked). In various embodiments, programs may be added to, or deleted from, the dislike list by a user.

In blocks 418, 420, and 422 the processor may perform operations as described with reference to like numbered blocks of method 400 (FIG. 5) to receive and output programmer alternate content.

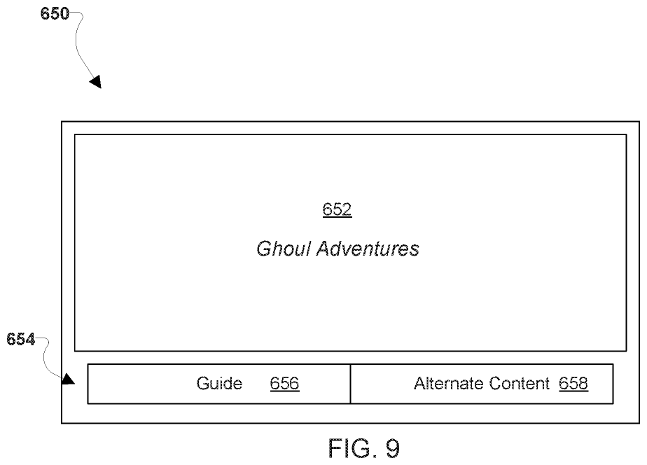

FIG. 9 is a block diagram illustrating an example user interface 650 configured to obtain user dislike data and support alternate content switching according to various embodiments. With reference to FIGS. 1-9, the user interface may display a current program 652, such as Ghoul Adventures, and below the current program 652 may display a program guide feature 654 with various icons, such as a guide icon 656 and an alternate content icon 658. The user interface 650 may be configured such that when the user selects the alternate content icon 658, a list of programmer alternate content that the user may select to replace the current program 652, such as Ghoul Adventures, may be displayed. Additionally, the user selection of the alternate content icon 658 may indicate the user finds the current program 652, such as Ghoul Adventures, unappealing.

FIG. 10 illustrates an embodiment method 700 for obtaining user dislike data. With reference to FIGS. 1-10, the operations of method 700 may be performed by a processor of a user computing device, such as user computing devices 107, 109, 110. As a specific example, the operations of method 700 may be performed by an ACG module running on a processor of a user computing device. In various embodiments, the operations of method 700 may be performed in conjunction with the operations of method 200 (FIG. 2), 300 (FIG. 4), 400 (FIG. 5), 500 (FIG. 6), and/or 600 (FIG. 8).

In block 702, the processor may indicate one or more programs to the user. For example, the processor may display a web portal or application to the user listing programs available for the user to watch on one or more channels.

In determination block 602, the processor may determine whether a user indicates a dislike as described with reference to like numbered block of method 600 (FIG. 6). The user may identify an unappealing (or disliked) program by selecting the program as disliked and indicating one or more other programs (i.e., programmer alternate content) available from the programmer providing the disliked program as preferred over the disliked program. As an example, the user may identify an unappealing (or disliked) program using a web portal provided by a content distributor network. As a further example, the user may identify an unappealing (or disliked) program via an application on a user's consumer device supported by an API to provide the user's identification of the disliked program to the content distributor network.

In response to determining no dislike is indicated (i.e., determination block 602=“No”), the processor may determine whether a user indicates a dislike removal in determination block 704. User's preferences for programs may change over time. As such, in various embodiments users may be enabled to remove programs from a dislike list. For example, via a web portal or application, a user may unselect a program as disliked to remove the program from a dislike list.

In response to determining that a dislike is indicated (i.e., determination block 602=“Yes”), the processor may the processor may perform operations as described with reference to like numbered blocks of method 600 (FIG. 6) in blocks 604, 606, and 608.

In response to determining a user indicates a dislike removal (i.e., determination block 704=“Yes”) or upon sending an indication of the user dislike and user selection of programmer alternate content in block 608, the processor may update the user dislike list in block 708. For example, the processor may add and/or remove programs from the dislike list. Upon updating the dislike list or in response to determining a user does not indicate a dislike removal (i.e., determination block 704=“No”), the processor may proceed to block 702.

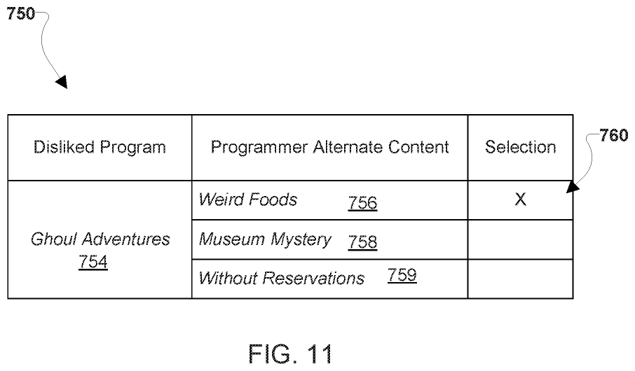

FIG. 11 is a block diagram illustrating an embodiment dislike list 750. With reference to FIGS. 1-11, the dislike list 750 may correlate disliked programs, programmer alternate content, and user selections. The programmer may have identified the programs Weird Foods 756, Museum Mystery 758, and Without Reservations 758, as available programmer alternate content for the program Ghoul Adventures 754. The user may indicate he or she dislikes the program Ghoul Adventures 754 by making a selection of the program Weird Foods 756 as the alternate content to replace the program Ghoul Adventures 754.

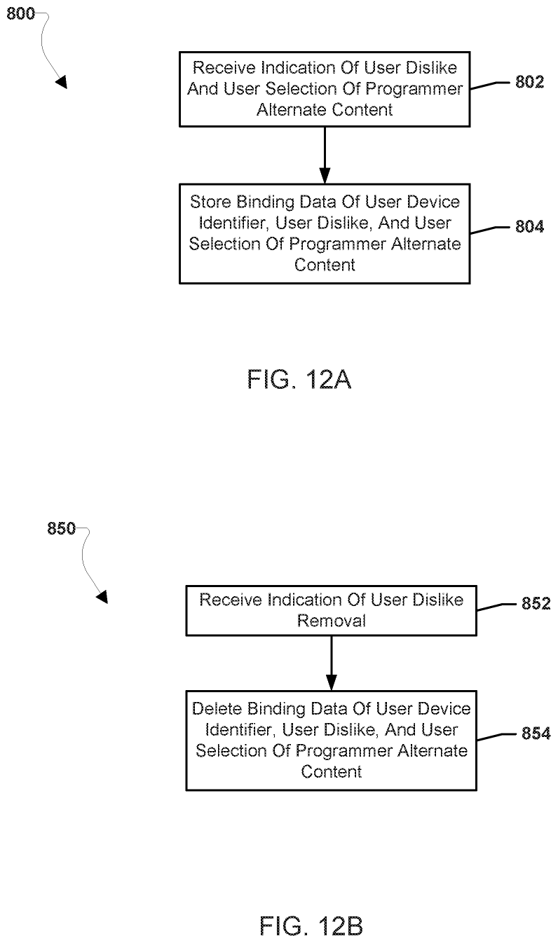

FIG. 12A illustrates an embodiment method 800 for storing binding data. With reference to FIGS. 1-8A, the operations of method 800 may be performed by a processor of a server of a content distributor network (e.g., content distributor network 105), such as an alternate content server (e.g., alternate content server 111). In various embodiments, the operations of method 850 may be performed in conjunction with the operations of method 200 (FIG. 2), method 300 (FIG. 4), method 400 (FIG. 5), 500 (FIG. 6), 600 (FIG. 8), and/or 700 (FIG. 10).

In block 802, the server may receive an indication of a user dislike and user selection of programmer alternate content. The indications may be received from a user computing device in response to a user indication of a disliked program.

In block 804, the server may store the binding data of the user identifier, the user dislike, and the user selection of programmer alternate content. In various embodiments, the binding data may relate an identifier of the user, such as the user's computing device identifier (e.g., MAC ID, etc.), subscribed identifier, etc., a user dislike (e.g., the name of the program disliked by the user, etc.), and the user selection of the programmer alternate content. In this manner, a database of user's disliked programs and the user's preferred programmer alternate content may be established at a server of a content distributor network, such as an alternate content server. Such binding data may be referenced to select programmer alternate content with which to replace unappealing (or disliked) programs for each respective user.

FIG. 12B illustrates an embodiment method 850 for deleting binding data. With reference to FIGS. 1-12B, the operations of method 850 may be performed by a processor of a server of a content distributor network (e.g., content distributor network 105), such as an alternate content server (e.g., alternate content server 111). In various embodiments, the operations of method 850 may be performed in conjunction with the operations of method 200 (FIG. 2), method 300 (FIG. 4), method 400 (FIG. 5), 500 (FIG. 6), 600 (FIG. 8), 700 (FIG. 10), and/or 800 (FIG. 12A).

In block 852, the processor may receive an indication of a user dislike removal. The indication may be received from a user computing device in response to a user changing a user preference to indicate a program is no longer disliked.

In block 854, the processor may delete the binding data of the user identifier, the user dislike, and the user selection of programmer alternate content.

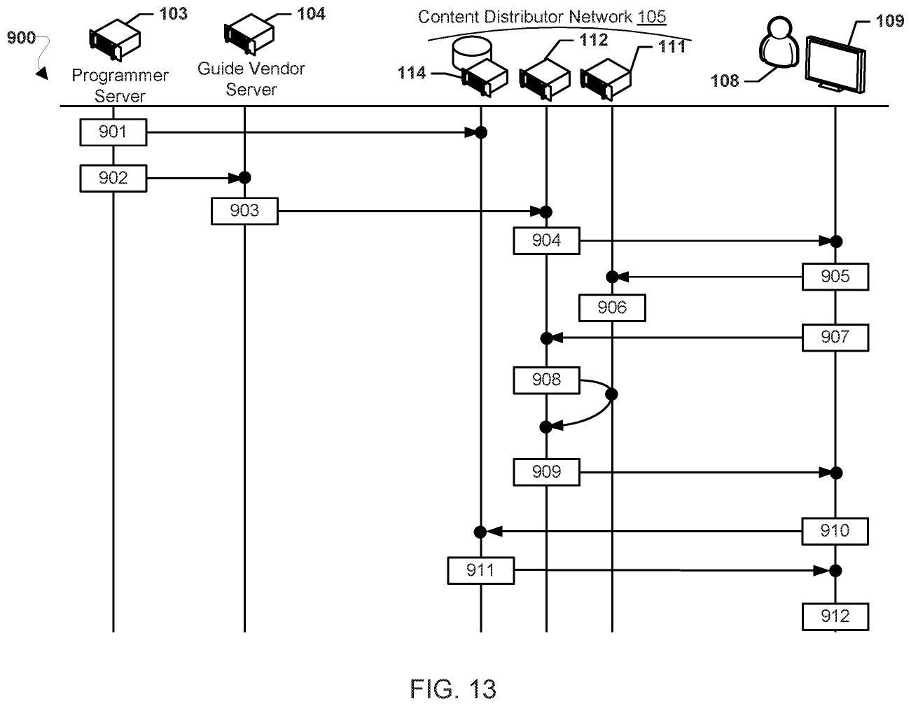

FIG. 13 is a call flow diagram illustrating an embodiment method 900 for alternate content switching. With reference to FIGS. 1-13, the operations of method 900 may be performed by a program server, such as programmer server 103, a guide vendor server, such as guide vendor server 104, computing devices of a content distributor network, such as origin server 114, manifest manipulator server 112, and alternate content server 111 of content distributor network 105, and a computing device of a user (e.g., user 108), such as user computing device 109 (e.g., a smart television). In various embodiments, the operations of method 900 may be performed in conjunction with, and correspond to, various operations of method 200 (FIG. 2), method 300 (FIG. 4), method 400 (FIG. 5), 500 (FIG. 6), 600 (FIG. 8), 700 (FIG. 10), 800 (FIG. 12A), and 850 (FIG. 12B).

In operation 901 the programmer server may provide programmer content, including original programs and alternate content programs, to the origin server.

In operation 902, the programmer server may send a program schedule and programmer alternate content mapping table to the guide vendor server.

In operation 903, the guide vendor server may generate and send a program guide indicating programmer alternate content availability to the manifest manipulator server. The manifest manipulator server may generate manifest files based on the program guide and send the program guide to the user computing device in operation 904. In operation 905, the user computing device may receive an indication of a user dislike of a program and a selection of programmer alternate content for that disliked program and provide the indication of the disliked program and user selected programmer alternate content to the alternate content server. The alternate content server may store binding data for the user computing device, the disliked program, and the programmer alternate content in operation 906.

In operation 907, the user computing device may determine that the dislike program is scheduled to be aired as the current program on a user selected channel and may send a manifest request for the current program and indication of the disliked program to the manifest manipulator server. In response to the indication of the disliked program, the manifest manipulator server may retrieve binding data for the user computing device, the current program, and the programmer alternate content from the alternate content server in operation 908. In operation 909, the manifest manipulator server may modify a manifest file for the current program according to the binding data to generate a manifest file for the programmer alternate content on the user selected channel and may send the manifest file for the programmer alternate content to the user computing device.

In operation 910, the user computing device may retrieve programmer alternate content for output on the user selected channel according to the manifest file for the programmer alternate content from the origin server. In operation 911, the origin server may stream the programmer alternate content to the user computing device. In operation 912, the user computing device may output the programmer alternate content to the user on the user selected channel.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 200, 300, 400, 500, 600, 700, 800, 850, and 900 may be substituted for or combined with one or more operations of the methods 200, 300, 400, 500, 600, 700, 800, 850, and 900 and vice versa.

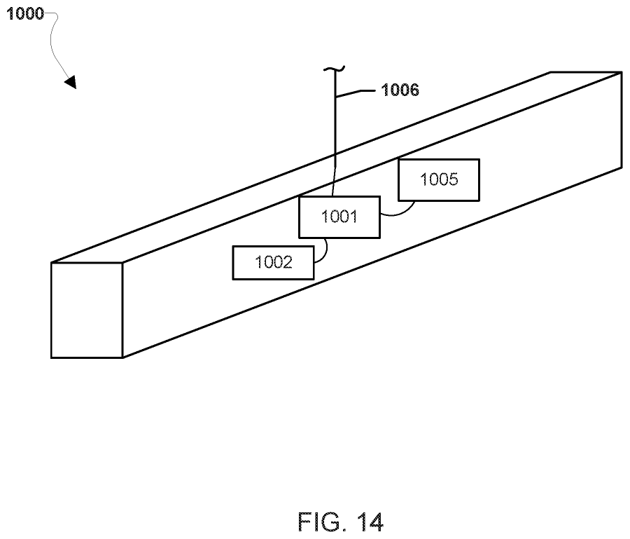

The various embodiments (including, but not limited to, embodiments discussed above with reference to FIGS. 1-13) may also be implemented on any of a variety of computing devices, such as a streaming media player 1000 illustrated in FIG. 14. Such a streaming media player 1000 typically includes a processor 1001 coupled to volatile memory 1002. The streaming media player 1000 may also include one or more connection or port 1006 coupled to the processor 1001 and configured to output streaming content to a display. The streaming media player 1000 may also include one or more network transceivers 1005, such as a network access port, coupled to the processor 1001 for establishing wired or wireless network interface connections with a communication network, such as a local area network coupled to other computing devices and routers/switches, the Internet, the public switched telephone network, and/or a cellular network (e.g., CDMA, TDMA, GSM, PCS, 3G, 4G, LTE, or any other type of cellular network). The streaming media player 1000 may receive media content via a network transceiver 1005 and output the media content to a display via the connection or port 1006.

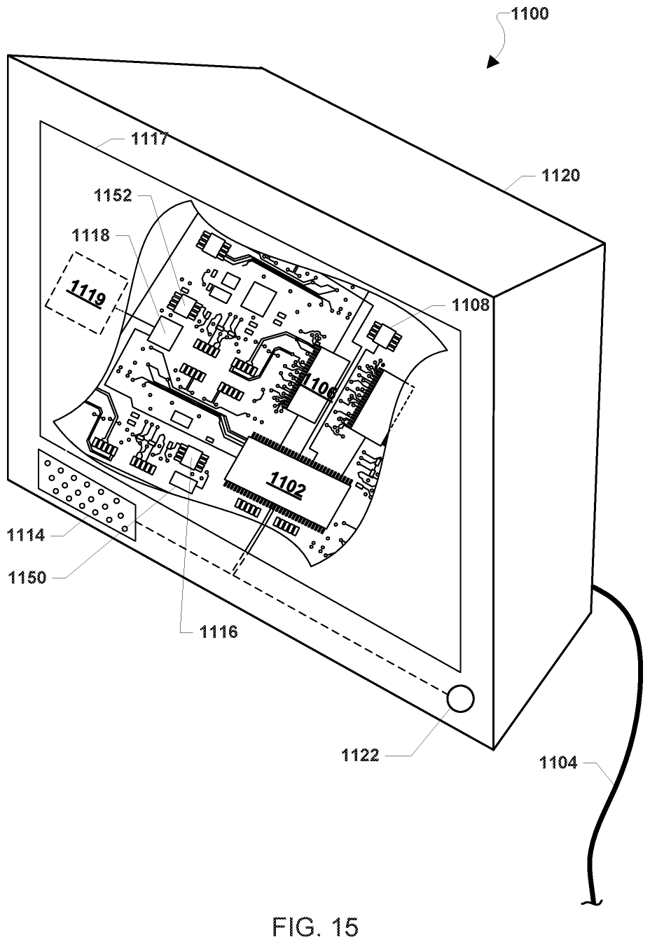

The various embodiments (including, but not limited to, embodiments discussed above with reference to FIGS. 1-13), may be implemented in any of a variety of computing devices (e.g., a smart television), an example of which is illustrated in FIG. 15. The smart television 1100 may include a processor 1102 and an internal memory 1106. The processor 1001 may be one or more multi-core integrated circuits designated for general or specific processing tasks. The internal memory 1106 may be volatile or non-volatile memory and may also be secure and/or encrypted memory, or unsecure and/or unencrypted memory, or any combination thereof. In another embodiment (not shown), the smart television 1100 may also be coupled to an external memory, such as an external hard drive. The smart television 1100 may have one or more satellite, cable, or terrestrial tuners 1108 coupled to the processor 1102. The one or more tuners 1108 may be used with the above-mentioned circuitry to receive and tune signals (e.g., television signals) received from a transmitter system (not shown) over a physical connection 1104 (e.g., a connection to a cable network, a connection to an antenna, etc.). The tuner 1108 and a connected antenna (internal to the television 1100 or connected via physical connection 1104 may be configured to receive IP streamed content.

The smart television 1100 may have one or more radio signal transceivers 1116 (e.g., Peanut®, Bluetooth®, Zigbee®, Wi-Fi, RF, cellular, etc.) and antennae 1150, for sending and receiving, coupled to each other and/or to the processor 1102. The transceivers 1116 and antennae 1150 may be used with the above-mentioned circuitry to implement various wireless transmission protocol stacks and interfaces. The smart television 1100 may include one or more cellular network wireless modem chips 1152, that enables communication via one or more cellular networks and that are coupled to the processor 1102. The one or more cellular network wireless modem chips 1152 may enable the smart television 1100 to receive broadcast services from one or more cellular networks (e.g., CDMA, TDMA, GSM, PCS, 3G, 4G, LTE, or any other type of cellular network).

The smart television 1100 may include a peripheral device connection interface 1118 coupled to the processor 1102. The peripheral device connection interface 1118 may be singularly configured to accept one type of connection or may be configured to accept various types of physical and communication interfaces/connections, common or proprietary, such as USB, FireWire, Thunderbolt, or PCIe. The peripheral device connection interface 1118 may also be coupled to a similarly configured peripheral device connection port (not shown), such as a connection port included on a conditional access module 1119 in communication with the television 1100.

The smart television 1100 may also include speakers 1114 for providing audio outputs. The smart television 1100 may also include a housing 1120, constructed of a plastic, metal, or a combination of materials, for containing all or some of the components discussed herein. The smart television 1100 may be connected to a power source (not shown), such as a wall outlet. The smart television 1100 may also include a physical button 1122 for receiving user inputs. The smart television 1100 may also include a display screen 1117 coupled to the processor 1102 and used for displaying visual images, such as television programs, etc.

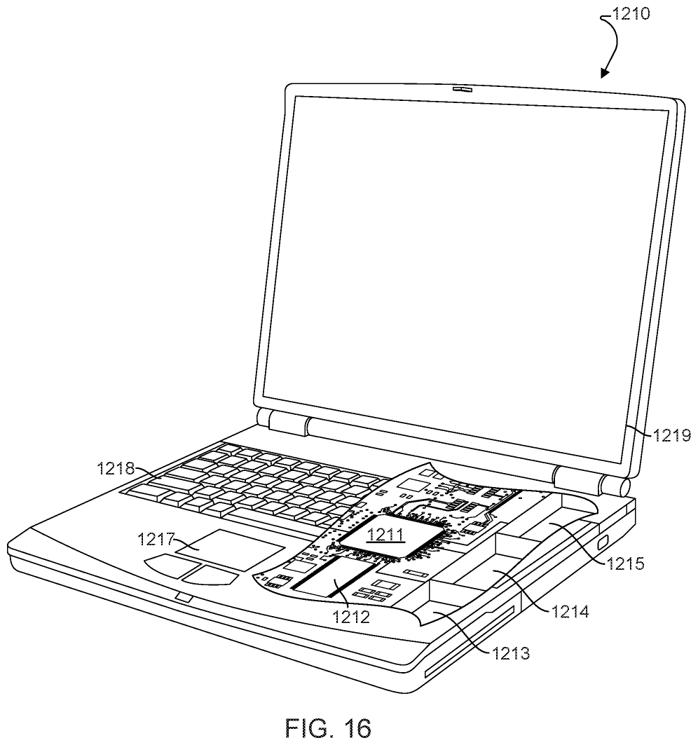

The various embodiments (including, but not limited to, embodiments discussed above with reference to FIGS. 1-13) described above may also be implemented within a variety of computing devices, such as a laptop computer 1210 as illustrated in FIG. 16. Many laptop computers include a touch pad touch surface 1217 that serves as the computer's pointing device, and thus may receive drag, scroll, and flick gestures similar to those implemented on mobile computing devices equipped with a touch screen display and described above. A laptop computer 1210 will typically include a processor 1211 coupled to volatile memory 1212 and a large capacity nonvolatile memory, such as a disk drive 1213 of Flash memory. The laptop computer 1210 may also include a floppy disc drive 1214 and a compact disc (CD) drive 1215 coupled to the processor 1211. The laptop computer 1210 may also include a number of connector ports coupled to the processor 1211 for establishing data connections or receiving external memory devices, such as a USB or FireWire® connector sockets, or other network connection circuits (e.g., interfaces) for coupling the processor 1211 to a network. In a notebook configuration, the computer housing may include the touchpad 1217, the keyboard 1218, and the display 1219 all coupled to the processor 1211. Other configurations of the computing device may include a computer mouse or trackball coupled to the processor (e.g., via a USB input) as are well known, which may also be use in conjunction with the various embodiments.

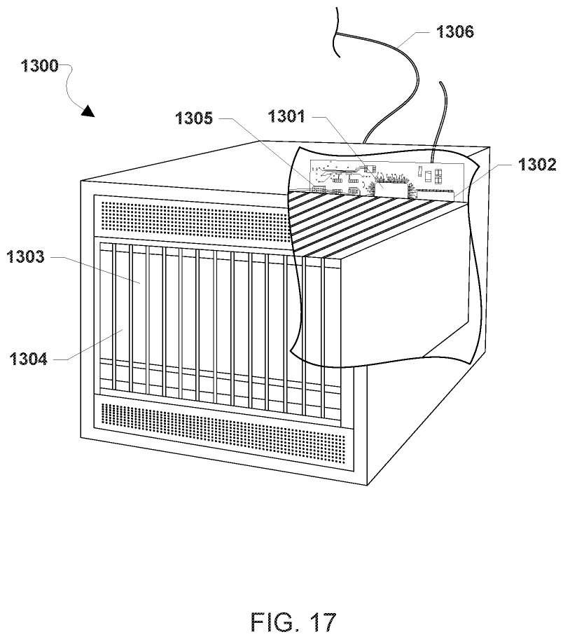

Various embodiments (including, but not limited to, embodiments discussed above with reference to FIGS. 1-13) may be implemented on any of a variety of commercially available server devices, such as the server 1300 illustrated in FIG. 17. Such a server 1300 may include a processor 1301 coupled to volatile memory 1302 and a large capacity nonvolatile memory, such as a disk drive 1303. The server 1300 may also include a floppy disc drive, compact disc (CD) or DVD disc drive 1304 coupled to the processor 1301. The server 1300 may also include network access ports 1306 coupled to the processor 1301 for establishing data connections with a network connection circuit 1305 and a communication network (e.g., IP network) coupled to other communication system network elements.

The processors 1001, 1102, 1211, 1301 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 1001, 1102, 1211, 1301. The processors 1001, 1102, 1211, 1301 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 1001, 1102, 1211, 1301 including internal memory or removable memory plugged into the device and memory within the processors 1001, 1102, 1211, 1301 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for alternate content switching, comprising:
determining, by a processor of a user computing device, that a current program on a user selected channel is on a dislike list;
determining, by the processor of the user computing device, that programmer alternate content is available based at least in part on an indication in a program guide in response to determining that the current program on the user selected channel is on the dislike list;
sending, from the processor of the user computing device, a manifest request for the current program on the user selected channel and a dislike indication in response to determining that programmer alternate content is available;
receiving, in the processor of the user computing device, a manifest file for programmer alternate content on the user selected channel; and
retrieving, by the processor of the user computing device, the programmer alternate content for output on the user selected channel according to the manifest file for the programmer alternate content on the user selected channel.

2. The method of claim 1, wherein the dislike list is stored in a memory of the user computing device and reflects a prior indication by a user that the current program is unappealing to the user.

3. The method of claim 1, further comprising:
receiving, in a processor of a network server, the manifest request for the current program on the user selected channel and the dislike indication;
retrieving, by the processor of the network server, binding data for the user computing device, the current program, and the programmer alternate content;
modifying, by the processor of the network server, a manifest file for the current program according to the binding data to generate the manifest file for the programmer alternate content on the user selected channel; and
sending, from the processor of the network server, the manifest file for the programmer alternate content on the user selected channel.

4. The method of claim 3, wherein the binding data is based at least in part on a selection of the programmer alternate content by a user from a plurality of available programs selected by a programmer providing the current program.

5. The method of claim 3, wherein retrieving the binding data comprises accessing a database correlating user indications of disliked programs and user indications of selected available programs to replace the disliked programs, wherein the selected available programs are defined by a programmer providing the current program.

6. The method of claim 3, wherein the dislike list is stored in a memory of the user computing device and reflects a prior indication by a user that the current program is unappealing to the user.

7. The method of claim 3, further comprising:
generating, by a processor of a programmer server, a programmer alternate content mapping table indicating programmer determined alternate content for one or more programs in a programming schedule of the programmer.

8. The method of claim 7, wherein the program guide is generated based at least in part on the programmer alternate content mapping table.

9. A method for alternate content switching, comprising:
receiving, in a processor of a network server, a manifest request for a current program on a user selected channel and a dislike indication from a user computing device;
retrieving, by the processor of the network server, binding data for the user computing device, the current program, and programmer alternate content, wherein the programmer alternate content comprises programmer determined alternate content for one or more programs in a programming schedule;
modifying, by the processor of the network server, a manifest file for the current program according to the binding data to generate a manifest file for the programmer alternate content on the user selected channel; and
sending, from the processor of the network server, the manifest file for the programmer alternate content on the user selected channel to the user computing device.

10. The method of claim 9, wherein retrieving the binding data comprises accessing a database correlating user indications of disliked programs and user indications of selected available programs to replace the disliked programs, wherein the selected available programs are defined by the programmer.

11. A computing device, comprising:
a memory; and
a processor connected to the memory, wherein the processor is configured with processor-executable instructions to perform operations comprising:
determining that a current program on a user selected channel is on a dislike list;
determining that programmer alternate content is available based at least in part on an indication in a program guide in response to determining that the current program on the user selected channel is on the dislike list;
sending a manifest request for the current program on the user selected channel and a dislike indication in response to determining that programmer alternate content is available;
receiving a manifest file for programmer alternate content on the user selected channel; and
retrieving the programmer alternate content for output on the user selected channel according to the manifest file for the programmer alternate content on the user selected channel.

12. The computing device of claim 11, wherein the processor-executable instructions are configured to cause the processor to perform operations such that the dislike list is stored in the memory and reflects a prior indication by a user that the current program is unappealing to the user.

13. A server, comprising:
a processor configured with processor-executable instructions to perform operations comprising:
receiving a manifest request for a current program on a user selected channel and a dislike indication from a user computing device;
retrieving binding data for the user computing device, the current program, and programmer alternate content, wherein the programmer alternate content comprises programmer determined alternate content for one or more programs in a programming schedule;
modifying a manifest file for the current program according to the binding data to generate a manifest file for the programmer alternate content on the user selected channel; and
sending the manifest file for the programmer alternate content on the user selected channel to the user computing device.

14. The server of claim 13, wherein the processor-executable instructions are configured to cause the processor to perform operations such that:
retrieving the binding data comprises accessing a database correlating user indications of disliked programs and user indications of selected available programs to replace the disliked programs; and
the selected available programs are defined by the programmer.

15. The server of claim 13, wherein the processor-executable instructions are configured to cause the processor to perform operations such that the binding data is based at least in part on a selection of the programmer alternate content by a user from a plurality of available programs selected by a programmer providing the current program.

16. A non-transitory processor readable medium having stored thereon processor-executable instructions configured to cause a processor to perform operations comprising:
determining that a current program on a user selected channel is on a dislike list;
determining that programmer alternate content is available based at least in part on an indication in a program guide in response to determining that the current program on the user selected channel is on the dislike list;
sending a manifest request for the current program on the user selected channel and a dislike indication in response to determining that programmer alternate content is available;
receiving a manifest file for programmer alternate content on the user selected channel; and
retrieving the programmer alternate content for output on the user selected channel according to the manifest file for the programmer alternate content on the user selected channel.

17. The non-transitory processor readable medium of claim 16, wherein stored processor-executable instructions are configured to cause a processor to perform operations such that the dislike list is stored in the memory and reflects a prior indication by a user that the current program is unappealing to the user.

18. A non-transitory processor readable medium having stored thereon processor-executable instructions configured to cause a processor to perform operations comprising:
receiving a manifest request for a current program on a user selected channel and a dislike indication from a user computing device;
retrieving binding data for the user computing device, the current program, and programmer alternate content, wherein the programmer alternate content comprises programmer determined alternate content for one or more programs in a programming schedule;
modifying a manifest file for the current program according to the binding data to generate a manifest file for the programmer alternate content on the user selected channel; and
sending the manifest file for the programmer alternate content on the user selected channel to the user computing device.

19. The non-transitory processor readable medium of claim 18, wherein stored processor-executable instructions are configured to cause a processor to perform operations such that:
retrieving the binding data comprises accessing a database correlating user indications of disliked programs and user indications of selected available programs to replace the disliked programs; and
the selected available programs are defined by the programmer.

20. The non-transitory processor readable medium of claim 18, wherein stored processor-executable instructions are configured to cause a processor to perform operations such that the binding data is based at least in part on a selection of the programmer alternate content by a user from a plurality of available programs selected by a programmer providing the current program.

21. A system, comprising:
a user computing device, comprising:
a first processor; and
a network server, comprising:
a second processor,
wherein the first processor is configured with processor-executable instructions to perform operations comprising:
determining that a current program on a user selected channel is on a dislike list;
determining that programmer alternate content is available based at least in part on an indication in a program guide in response to determining that the current program on the user selected channel is on the dislike list; and
sending a manifest request for the current program on the user selected channel and a dislike indication to the network server in response to determining that programmer alternate content is available,
wherein the second processor is configured with processor-executable instructions to perform operations comprising:
receiving the manifest request for the current program from the user computing device;
retrieving binding data for the user computing device, the current program, and programmer alternate content, wherein the programmer alternate content comprises programmer determined alternate content for one or more programs in a programming schedule;
modifying a manifest file for the current program according to the binding data to generate a manifest file for the programmer alternate content on the user selected channel; and
sending the manifest file for the programmer alternate content on the user selected channel to the user computing device,
wherein the first processor is configured with processor-executable instructions to perform operations further comprising:
receiving the manifest file for the programmer alternate content on the user selected channel from the network server; and
retrieving the programmer alternate content for output on the user selected channel according to the manifest file for the programmer alternate content on the user selected channel.

22. The system of claim 21, wherein the user computing device further comprises a memory connected to the first processor, and wherein the first processor is configured with processor-executable instructions to perform operations such that the dislike list is stored in the memory and reflects a prior indication by a user that the current program is unappealing to the user.

23. The system of claim 21, further comprising a database correlating user indications of disliked programs and user indications of selected available programs to replace the disliked programs,
wherein:
the selected available programs are defined by the programmer, and
the second processor is configured with processor-executable instructions to perform operations such that retrieving the binding data comprises accessing the database.

24. The system of claim 21, wherein the second processor is configured with processor-executable instructions to perform operations such that the binding data is based at least in part on a selection of the programmer alternate content by a user from a plurality of available programs selected by a programmer providing the current program.

25. The system of claim 21, further comprising a programmer server comprising a third processor,
wherein the third processor is configured with processor-executable instructions to perform operations comprising generating a programmer alternate content mapping table indicating programmer determined alternate content for one or more programs in a programming schedule of the programmer.

26. The system of claim 25, wherein the third processor is configured with processor-executable instructions to perform operations such that the program guide is generated based at least in part on the programmer alternate content mapping table.
